(19) United States
(12) Patent Application Publication
(10) Pub. No.: US 2024/0162709 A1
(43) Pub. Date: May 16, 2024

(54) CIRCUIT FOR CONNECTING OR DISCONNECTING A POWER SOURCE/CONSUMER TO AN AC NETWORK

(71) Applicant: Blixt Tech AB, Kista (SE)

(72) Inventor: Jan Johansson, Solna (SE)

(73) Assignee: Blixt Tech AB, Kista (SE)

(21) Appl. No.: 18/284,435

(22) PCT Filed: Mar. 22, 2022
(86) PCT No.: PCT/EP2022/057462

§ 371 Date: Sep. 27, 2023

(30) Foreign Application Priority Data
Mar. 31, 2021 (SE) 2150412-1

(51) Int. Cl. H02J 3/01; H02J 3/14

(52) U.S. Cl. CPC H02J 3/01; H02J 3/14

(57) ABSTRACT

The invention relates to a circuit for connecting or disconnecting a power consumer and/or a power source to an AC network. The circuit (100) comprises a voltage divider (110) which provides a divided or scaled voltage (V1; V2) of an AC voltage (Vac) of the AC network. The circuit (100) also comprises a controller (120) configured to receive the divided voltage (V1; V2) and provide a control signal (CS) to a power consumer (210) and/or a power source (220) when the divided voltage (V1; V2) crosses a threshold trigger voltage (Vth) of the controller (120) so as to connect or disconnect the power consumer (210) and/or the power source (220) to the AC network (300). Furthermore, the invention also relates to a corresponding method.

### TECHNICAL FIELD

The invention relates to a circuit for connecting or disconnecting a power consumer and/or a power source to an AC network. Furthermore, the invention also relates to a corresponding method.

### BACKGROUND

Mains electricity or mains current, also known as utility power or power grid, is an alternating current (AC) power delivered to home and industry through an electrical infra structure. The voltage and frequency of the AC current may differ for different countries and e.g. the nominal voltage and frequency is 230V and 50 Hz, respectively, in Europe whilst in North America the nominal voltage and frequency is 120V and 60 Hz, respectively.

The quality of the AC is an important factor having both economic and safety implications. When power consumers and power sources are switched from connected mode to disconnected mode, or vice versa, the power quality of the AC network will be influenced negatively since the switching will result in reduced quality of the AC. Zero crossing (ZC) is an instantaneous point when there is no voltage, i.e. 0V, present of the AC sine waveform. The zero crossing occurs twice for each sine wave cycle. For no or minimum negative impact on the quality of the AC ideally the power consumer or the power source should connect or disconnect more or less exactly at the zero crossing of the sine wave. If that is not the case the power quality of the AC network will be reduced due to distortion caused by the non-ideal switching timing.

### SUMMARY

An objective of embodiments of the invention is to provide a solution which mitigates or solves the drawbacks and problems of conventional solutions.

Another objective of embodiments of the invention is to provide a solution in which a power consumer and/or a power source can be connected or disconnected to an AC network with high accuracy.

The above and further objectives are solved by the subject matter of the independent claims. Further advantageous embodiments of the invention can be found in the dependent claims.

According to a first aspect of the invention, the above mentioned and other objectives are achieved with a circuit for connecting or disconnecting a power consumer and/or a power source to an AC network, the circuit comprising:
a voltage divider comprising:
   an input configured to receive an AC voltage of an AC network,
   an output configured to provide a divided voltage of the AC voltage;
a controller comprising:
   an input connected to the output of the voltage divider and configured to receive the divided voltage,
   a control output connected to a power consumer and/or a power source for controlling
   the power consumer and/or the power source;
wherein the controller is configured to:
   provide a control signal to the power consumer and/or the power source when the divided voltage crosses a threshold trigger voltage of the controller so as to connect or disconnect the power consumer and/or the power source to the AC network.

The AC voltage may be considered as a sine (sinusoidal) waveform AC voltage. In such case the divided voltage has also a sinusoidal waveform. The AC network may e.g. be a mains current network. The power consumer is an electrical device that consumes electrical power from the AC network for its functioning. The power source, also denoted power supply, is an electrical device that delivers electrical power to the AC network. The control signal can be provided to the power consumer and/or the power source via one or more control lines of a control system. That the divided voltage crosses the threshold trigger voltage may be understood to mean that the divided voltage has a value that is equal to the threshold trigger voltage or within an interval comprising the threshold trigger voltage.

In the case the power source is an AC network, the circuit according to the first aspect provides a solution for connecting or disconnecting two different AC networks.

An advantage of the circuit according to the first aspect is that it is provided a solution in which a timing in the time domain is translated to a scaling in the voltage domain. Therefore, by proper voltage scaling of the AC voltage and by considering a threshold voltage of the controller any power consumer or power source controlled by the controller can be connected or disconnected to the AC network with high accuracy.

In an implementation form of a circuit according to the first aspect, the absolute value or the modulus of the threshold trigger voltage is larger than zero.

In an implementation form of a circuit according to the first aspect, the absolute value of the threshold trigger voltage is smaller than the maximum amplitude value of the AC voltage.

In an implementation form of a circuit according to the first aspect, the amplitude of the divided voltage is smaller than the amplitude of the AC voltage.

In an implementation form of a circuit according to the first aspect, the divided voltage has the same periodicity as the AC voltage.

In an implementation form of a circuit according to the first aspect, the controller is configured to provide the control signal at an offset time period being a time period when the divided voltage crosses the threshold trigger voltage previous to or after a zero crossing of the AC voltage.

The offset time period may also be denoted an offset trigger time period. The offset time period may be dependent on the divided voltage and the threshold trigger voltage.

In an implementation form of a circuit according to the first aspect, the offset time period is dependent on a control time delay being a sum of all time delays contributing to a total time period for connecting or disconnecting the power consumer and/or the power source to the AC network at the zero crossing of the AC voltage.

In an implementation form of a circuit according to the first aspect, the controller is configured to
provide the control signal so as to connect or disconnect the power consumer and/or the power source to the AC network at a zero crossing of the AC voltage.

An advantage with this implementation form is that the power consumer and/or the power source is connected to or disconnected from the AC network at the zero crossing of the AC sine waveform thereby reducing distortion in the AC network for improved quality.

In an implementation form of a circuit according to the first aspect, the voltage divider is a resistive voltage divider comprising
a first resistor connected in series with a second resistor, wherein a first side of the first resistor is connected to the AC network for receiving the AC voltage of the AC network and a second side of the first resistor is connected to a first side of the second resistor; and wherein
the output of the voltage divider is arranged between the first resistor and the second resistor.

Since the voltage divider only comprises passive electrical components in the form of resistors at least the following advantages are provided: resistors are low-cost components, resistors are not sensitive to changes in temperature and humidity and therefore robust, and resistors have high accuracy resistive values also meaning high accuracy implementations.

In an implementation form of a circuit according to the first aspect, a second side of the second resistor is configured to receive a DC voltage, and wherein a value of the DC voltage is dependent on an offset time period being a time period when the divided voltage crosses the threshold trigger voltage previous to or after the zero crossing of the AC voltage.

An advantage with this implementation form is that a simple and efficient design is provided for dividing the AC voltage into the divided voltage. Further, the amplitude of the divided voltage can be controlled by controlling the DC voltage feed to the second resistor.

In an implementation form of a circuit according to the first aspect, a value of the DC voltage is dependent on an offset time period being a time period when the divided voltage crosses the threshold trigger voltage previous to or after the zero crossing of the AC voltage.

In an implementation form of a circuit according to the first aspect,
the DC voltage is constant when the offset time period is smaller than an offset threshold time period; or
the DC voltage alternates between a low value and a high value when the offset time period is larger than an offset threshold time period.

An advantage with this implementation form is that only one value of the DC voltage is needed implying simple design and hence a low-cost implementation when the offset time period is smaller than the offset threshold time period.

An advantage with this implementation form is that the circuit according to the first aspect can handle the case when the offset time period is larger than the offset threshold time period.

In an implementation form of a circuit according to the first aspect, the DC voltage alternates between a low value and a high value, and wherein the DC voltage has a low value when the AC voltage waveform has a negative incline, and a high value when the AC voltage waveform has a positive incline.

In an implementation form of a circuit according to the first aspect, the low voltage value is 0V, and the high voltage value is dependent on the trigger threshold voltage of the controller.

In an implementation form of a circuit according to the first aspect, the second side of the second resistor is connected to a DC output of the controller, and wherein the DC output is configured to provide the DC voltage to the voltage divider.

In examples an inverted DC output of the controller is used.

An advantage with this implementation form is that a low complex and low-cost implementation may be provided by using controllers having a DC output, e.g. a micro-controller.

In an implementation form of a circuit according to the first aspect, a resistance value of the first resistor is constant and a resistance value of the second resistor is adjustable, or vice versa; or
a resistance value of the first resistor is a first constant value and a resistance value of the second resistor is a second constant value.

In an implementation form of a circuit according to the first aspect, the adjustable resistance value or the DC voltage is adjusted based on a distortion information about the AC voltage.

An advantage with this implementation form is that by using such feedback distortion information the adjustable resistance value can be fine-tuned for improved performance, e.g. more exact connection or disconnection at the zero crossing of the sine waveform.

According to a second aspect of the invention, the above mentioned and other objectives are achieved with an arrangement comprising:
a circuit according to any one of the implementation forms of the first aspect, and
a power consumer and/or a power source.

According to a third aspect of the invention, the above mentioned and other objectives are achieved with a method for connecting or disconnecting a power consumer and/or a power source to an AC network, the method comprising:
receiving an AC voltage of an AC network,
dividing the AC voltage for obtaining a divided voltage of the AC voltage; and
providing a control signal to a power consumer and/or a power source so as to connect or disconnect the power consumer and/or the power source to the AC network when the divided voltage crosses a threshold trigger voltage.

The method according to the third aspect may be implemented according to the corresponding implementation forms of the circuit according to the first aspect.

The advantages of the method according to the third aspect are the same as the corresponding implementation forms of the circuit according to the first aspect.

Further applications and advantages of the embodiments of the invention will be apparent from the following detailed description.

### BRIEF DESCRIPTION OF THE DRAWINGS

The appended drawings are intended to clarify and explain different embodiments of the invention, in which:

FIG. 1 shows a circuit according to an embodiment of the invention;

FIGS. 2 and 3 illustrates different aspects and embodiments of the invention

FIGS. 4 to 7 show circuits according to embodiments of the invention;

FIGS. 8 to 11 illustrates different aspects and embodiments of the invention;

FIG. 12 shows an adjustable resistive network for tuning voltage scaling according to an embodiment of the invention;

FIG. 13 shows a PWM and an integrator according to an embodiment of the invention;

FIG. 14 shows a method according to an embodiment of the invention; and

FIG. 15 shows an arrangement according to an embodiment of the invention.

### DETAILED DESCRIPTION

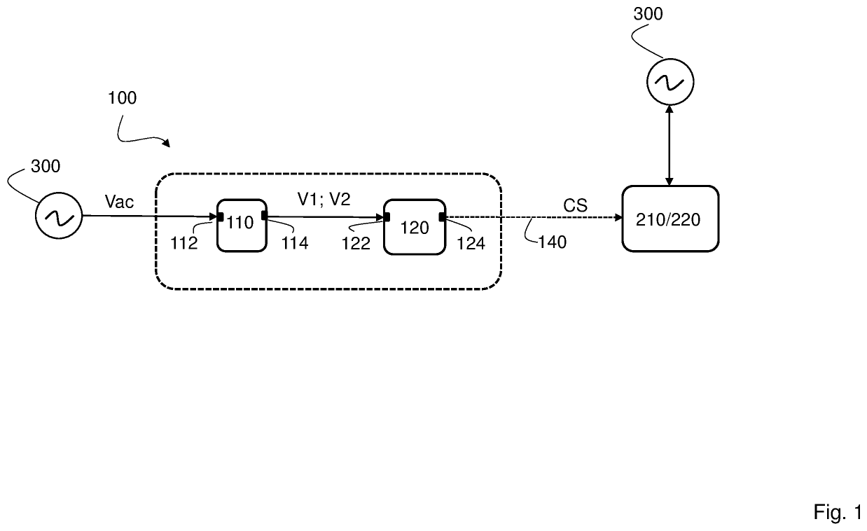

FIG. 1 shows a circuit 100 for connecting or disconnecting a power consumer and/or a power source to an AC network according to embodiments of the invention. The circuit 100 comprises a voltage divider 110 which in turn comprises an input 112 configured to receive an AC voltage Vac of an AC network 300, e.g. a mains power grid. The voltage divider 110 further comprises an output 114 configured to provide a divided voltage V1; V2, also denoted a scaled voltage, of the AC voltage Vac. Hence, the present voltage divider 110 is configured to scale the AC voltage Vac.

The circuit 100 further comprises a controller 120 which in turn comprises an input 122, also denoted a trigger input, connected to the output 114 of the voltage divider 110 and configured to receive the divided voltage V1; V2 from the voltage divider 110. The controller 120 also comprises a control output 124 connected to a power consumer 210 and/or a power source 220 for controlling the power consumer 210 and/or the power source 220. The controller 120 is configured to provide a control signal CS, e.g. via a control line 140, to the power consumer 210 and/or the power source 220 when the divided voltage V1; V2 crosses a threshold trigger voltage Vth of the controller 120 so as to connect or disconnect the power consumer 210 and/or the power source 220 to the AC network 300.

In embodiments of the invention, the power source is an AC network, and hence the circuit 100 according to the invention also provides a solution for connecting or disconnecting two different AC networks.

The controller 120 herein used may be of many different types and may have different trigger voltages. For example, a so-called micro controller may be used. However, also circuits comprising comparators, inverters, OP amps, etc. may be used in this respect. The threshold trigger voltage Vth may also differ for the different controller types. For example, the threshold trigger voltage may be half the feeding voltage of the controller 120, such as 1.65V when the feeding voltage is 3.3V. It should be noted that the absolute value or the modulus of the threshold trigger voltage Vth is larger than zero according to embodiments of the invention. The absolute value of the threshold trigger voltage Vth is further smaller than the maximum amplitude of the AC voltage sine waveform in embodiments of the invention.

When the power consumer 210 is connected to the AC network 300, the power consumer consumes electrical power delivered by the AC network. Non-limiting examples of power consumers may be household appliances, industrial power consumer applications, etc. Correspondingly, when the power source 220 is connected to the AC network 300, the power source delivers electrical power to the AC network. Non-limiting examples of power sources may be batteries, battery power grids, solar power plants, wind power plants, AC networks, and combinations thereof.

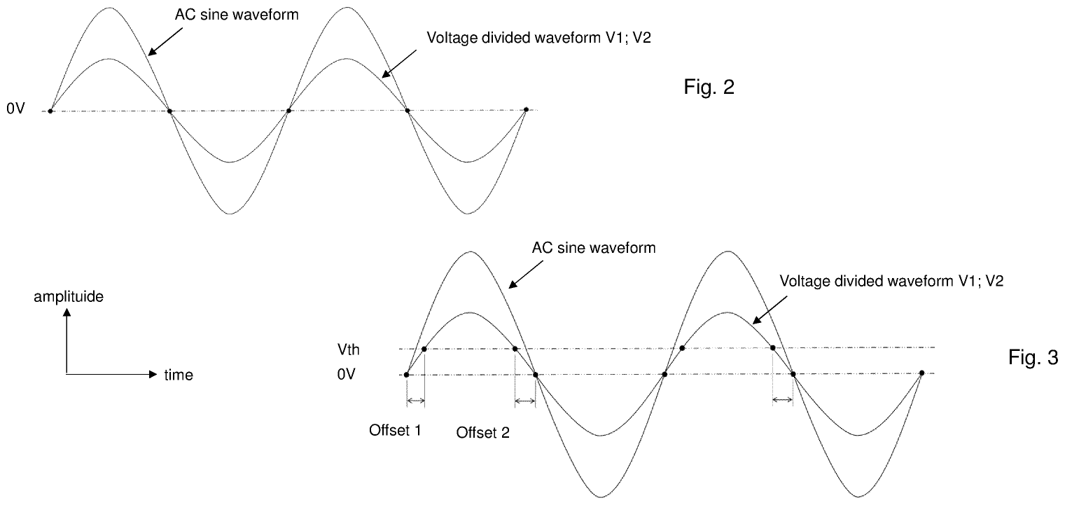

FIGS. 2 and 3 illustrate different aspects of the invention in regard to an AC sine waveform of the AC network. The x-axis illustrates time and the y-axis the amplitude of the AC sine waveform which may have any suitable nominal voltage and frequency, e.g. 230V and 50 Hz or 160V and 60 Hz.

In FIG. 2 it is disclosed an original AC sine waveform of a mains current having the typical cyclic amplitude characteristic around the zero voltage 0V with a certain periodicity. Further, a voltage divided sine waveform is also illustrated in FIG. 2. The divided voltage sine waveform may be considered as a scaled waveform version of the original AC sine waveform. For example, if the original AC sine waveform has 230V nominal voltage, the divided voltage may have a nominal voltage that is equal to 230V*sf, where sf is a scaling factor having a value between 1 and 0. Hence, if sf=0.5 the nominal voltage of the divided voltage is equal to 230V*0.5=115V. This means that the divided voltage has an amplitude that is smaller than the amplitude of the original AC sine waveform. It may however be noted that the divided or scaled voltage has the same periodicity as the original AC sine waveform. Therefore, at the zero crossing both the AC sine waveform and the divided sine waveform cross the zero voltage 0V at the same time instance as shown in FIG. 2.

However, if a trigger threshold voltage of the controller 120 is considered as shown in FIG. 3 the following may be noted. The divided or scaled voltage crosses the trigger threshold voltage Vth with a time offset compared to when the AC voltage crosses the zero voltage 0V. In the particular example shown in FIG. 3 the time offset is negative Offset 1, meaning that the divided voltage crosses the threshold voltage after the AC voltage crosses the zero voltage, when the incline or the derivate of the AC sine wave has a positive value, and the time offset is positive Offset 2, meaning that the divided voltage crosses the threshold voltage before the AC voltage crosses the zero voltage, when the incline or the derivate of the AC sine wave has a negative value but embodiments of the invention are not limited thereto. By adapting the scaling of the AC voltage Vac to the trigger threshold value Vth of the controller 120 and a control time delay Tc the controller 120 may be triggered such that providing the control signal CS so as to connect or disconnect the power consumer 210 and/or the power source 220 to the AC network 300 at zero crossings of the AC voltage Vac. Naturally, the revers case is also possible, i.e., to adapt the trigger threshold value Vth to the scaled or divided voltage. This implies that the trigger threshold value Vth and the scaled or divided voltage is dependent on each other.

The mentioned control time delay Tc may be considered as a sum of all time delays or time periods contributing to a total time period Ttot from the time instance the controller 120 is triggered to provide the control signal to the time instance when the power consumer 210 and/or the power source 220 is actually connected or disconnected to the AC network 300. Therefore, according to the present invention, the total time period Ttot may considered to be translated from the time domain to the voltage domain by scaling the original AC voltage of the AC network 300 in dependence on the trigger threshold voltage Vth. Non-limiting examples of parameters that contributes to the control time delay may be time of autonomous logic, raise and fall time of driver(s), and raise and fall time of switches in the chain from the controller 120 to the actual switching instance.

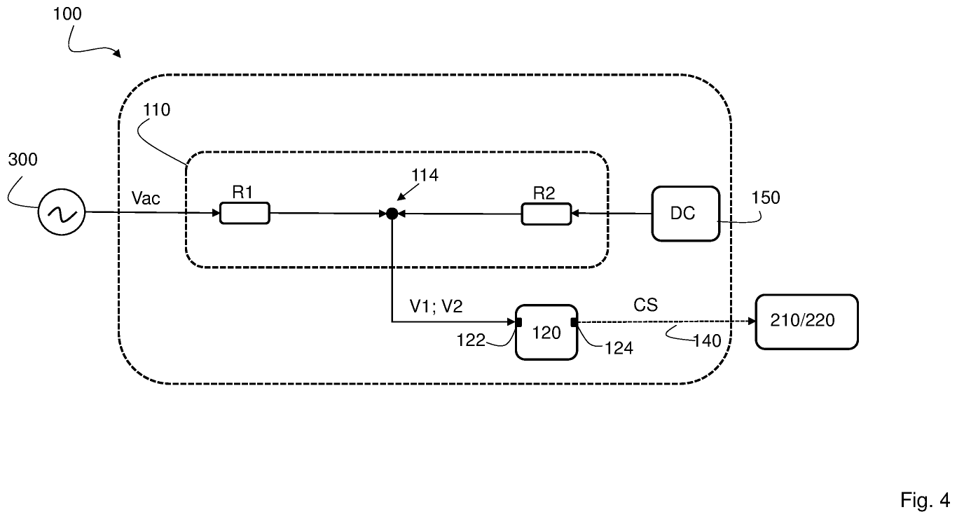

In embodiments of the invention, the voltage divider 110 is a pure resistive voltage divider as shown in FIGS. 4 to 7. In such embodiments the voltage divider 110 may comprise a first resistor R1 connected in series with a second resistor R2. Furthermore, a first side of the first resistor R1 is connected to the AC network 300 for receiving the AC voltage Vac of the AC network 300, and a second side of the first resistor R1 is connected to a first side of the second resistor R2. In such examples, the output 114 of the voltage divider 110 is arranged at a node between the first resistor R1 and the second resistor R2 as shown in FIG. 4. This implies that the output 114 of the voltage divider 110 is electrically connected to the trigger input 122 of the controller 120.

As also disclosed in FIG. 4 and according to further embodiments of the invention, a second side of the second resistor R2 may be configured to receive a DC voltage. Thus, by feeding a DC voltage to the second resistor R2 the scaling of the AC voltage waveform can be controlled. Hence, the circuit 100 may comprise any suitable DC voltage generator 150 which is configured to provide the DC voltage to the second resistor R2.

The DC voltage feed to the second resistor R2 may generally have two different characteristics, i.e. the DC voltage may have a constant value or may alternate between two or more different DC values since it has been realized that the value of the DC voltage may be dependent on the offset time period which may be defined as a time period when the divided voltage crosses the threshold trigger voltage Vth previous to or after the zero crossing of the AC voltage Vac.

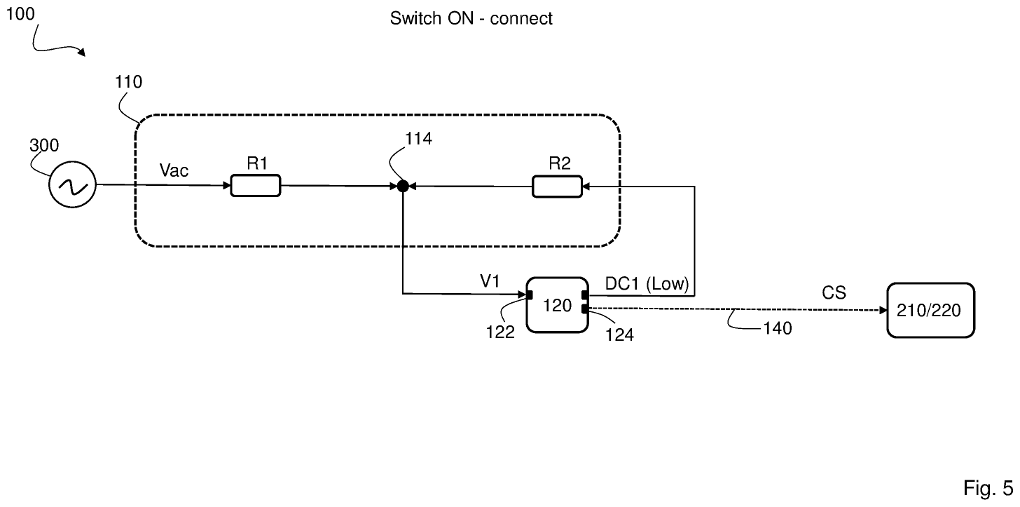

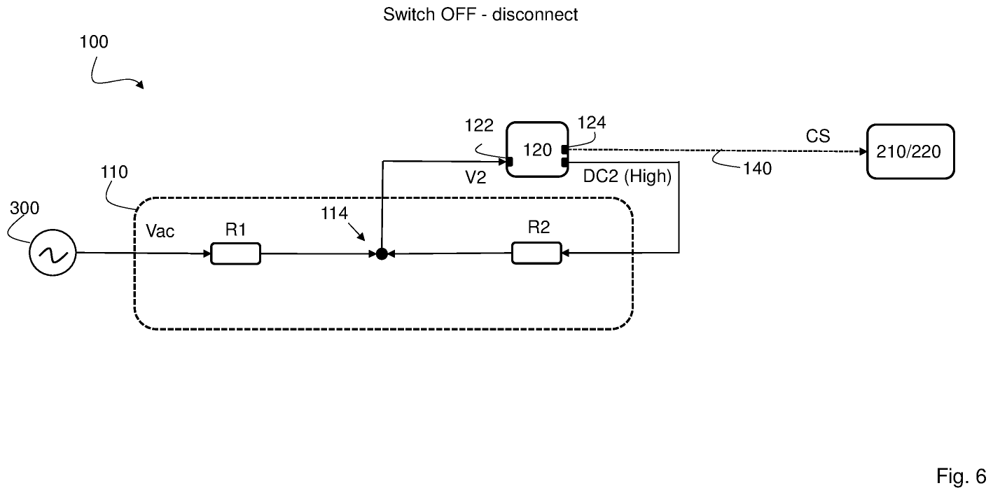

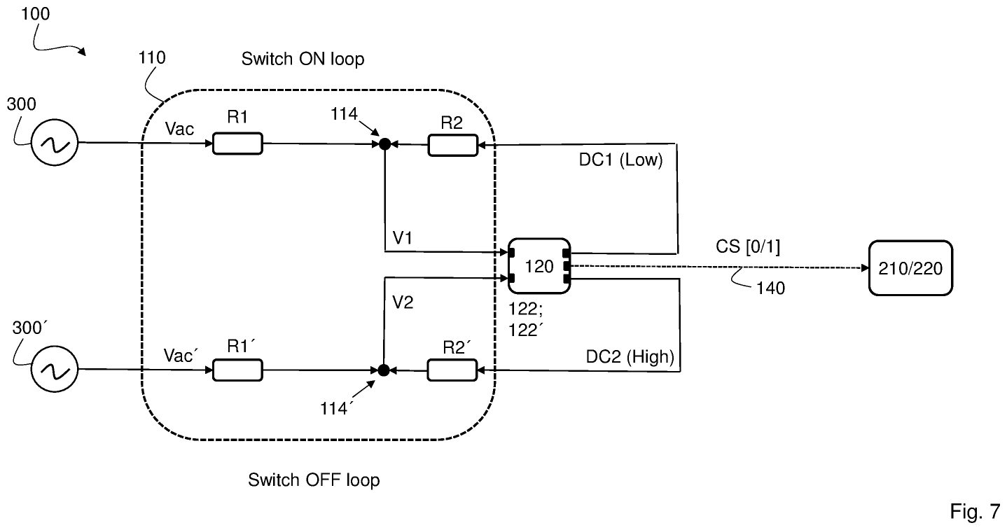

Therefore, in embodiments of the invention the DC voltage alternates between a low DC value DC1 and a high DC value DC2 when the offset time period is larger than an offset threshold time period as shown in FIGS. 5 to 7; where FIG. 5 shows a circuit for the low value DC case, FIG. 6 shows a circuit for the high value DC case, and FIG. 7 shows a combined circuit for both the high value and the low value cases. With reference to FIGS. 5 to 7, the DC voltage may have a low value when the AC voltage Vac waveform has a negative incline, and a high value when the AC voltage Vac waveform has a positive incline.

It may generally be considered that when a power consumer 210 is to be connected to the AC network, the power consumer should switch on at the zero voltage since no current is flowing in the circuit. This case is illustrated in FIG. 5. When the power consumer 210 is in a connected state to the AC network and is to be disconnected from the AC network the power consumer should switch off at the zero current since current is running in the circuit. This case is illustrated in FIG. 6. Therefore, in the latter case current values may have to be translated or converted into voltage values which may be obtained by e.g. using Hall effect sensors, flux gate transformers, etc. When the current values or the current wave form has been translated into a translated voltage waveform, the present solution of voltage scaling and using threshold values and time delays can be applied. Finally, FIG. 7 shows a combined circuit having an upper switch on loop and a lower switch off loop, respectively. The control signal CS may in implementations have a binary value e.g. 0/1 as also shown in FIG. 7. The binary value 0/1 may indicate a connect signal and a disconnect signal, respectively.

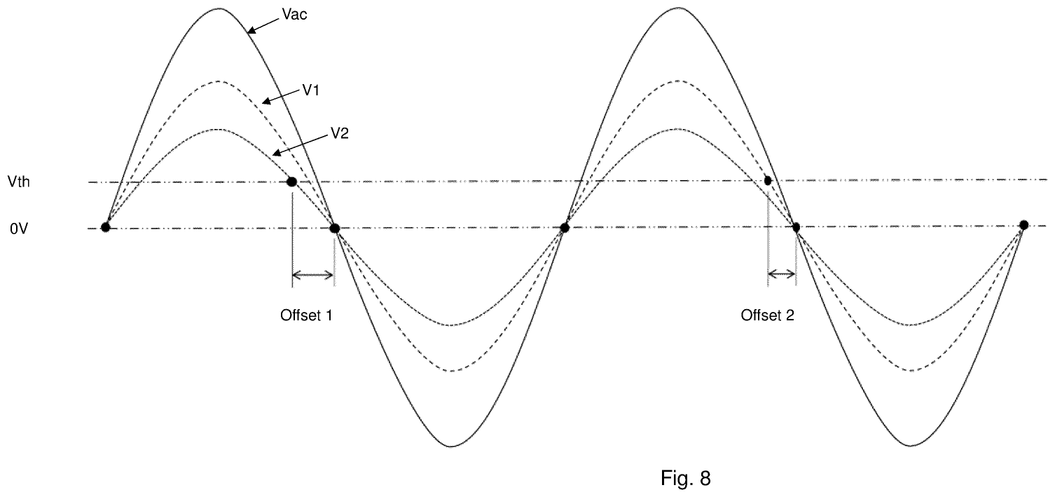

FIG. 8 illustrates when the low DC voltage value is 0 V, and the high DC voltage value is dependent on the trigger threshold voltage Vth of the controller 120. In such embodiments two different scaled voltage waveforms may be used for triggering the controller 120 as shown in FIG. 8. The first scaled voltage V1 is the scaled waveform when the DC value is high and the second scaled voltage V2 is the scaled waveform when the DC value is low. It is noted that Offset 1 corresponding to the second scaled voltage V2 and Offset 2 corresponding to the first scaled voltage V1 have different values for the same threshold value due to the different voltage scaling.

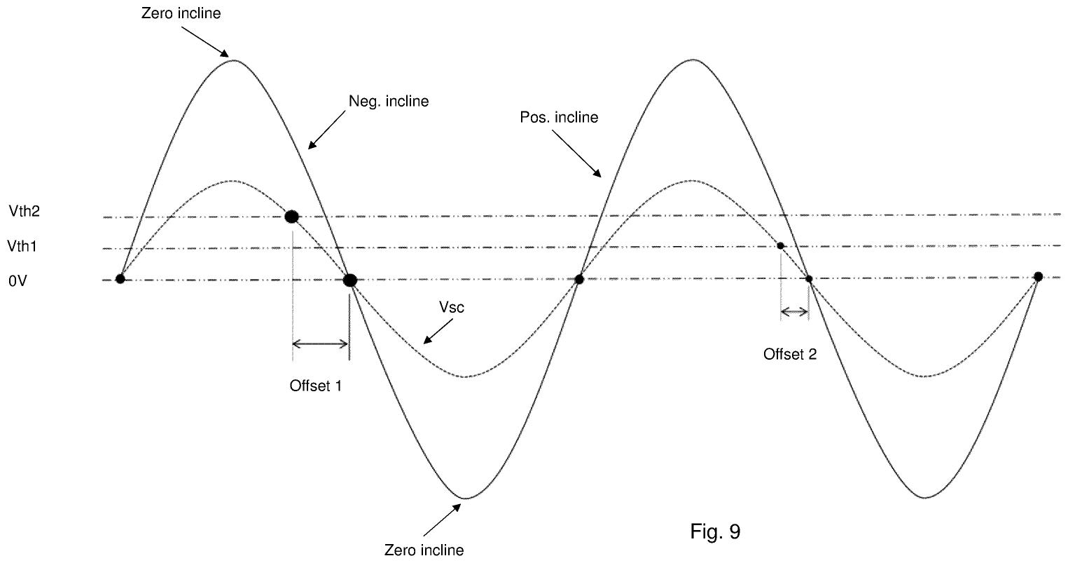

FIG. 9 on the other hand illustrates when two different trigger thresholds Vth1, Vth2 are used but only one scaled voltage Vsc. As shown different threshold values will result in different offset values. Offset 1 corresponds to the second threshold value Vth2 and Offset 2 corresponds to the first threshold value Vth1.

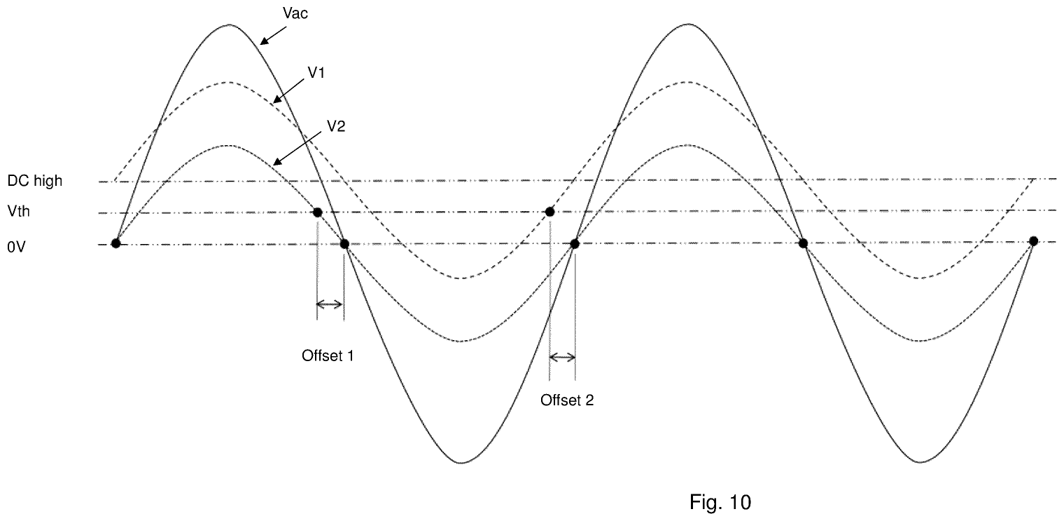

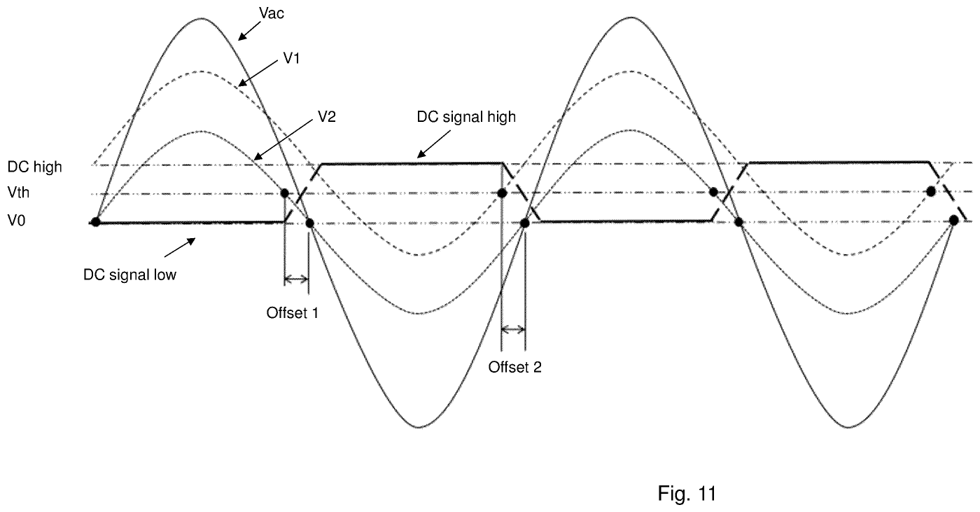

Moreover, FIGS. 10 and 11 illustrate two scaled voltages V1 and V2, respectively, which are used depending on the incline or derivate of the AC voltage Vac. As noted from FIGS. 10 and 11 depending on the incline or derivate of the AC voltage waveform either V1 or V2 may be used for triggering the controller 120.

In FIG. 11 the value of the DC voltage provided to the voltage divider 110 is also illustrated for the alternating DC case with bold full and dashed lines. It may be noted that the DC value is low (0V) when the AC voltage has a negative incline which means that the second scaled voltage V2 is the trigger voltage at the first time offset. It may further be noted that the DC voltage starts to raise to the high value when the second scaled voltage V2 has crossed the threshold voltage Vth. The first scaled voltage V1 is the trigger voltage when the DC voltage has the high value which happens when the AC voltage has a positive incline.

However as previously mentioned, in other embodiments of the invention the DC voltage may instead have a constant value, such as a positive DC value. It has namely been realized that when the offset time period T1; T2 is smaller than an offset threshold time period Tth the DC voltage may have a constant value and when the offset time period T1; T2 is larger than the offset threshold time period Tth the DC voltage may be alternating between a high value and low value.

For example, in USA 120V/60 Hz when R1 is 1000 kΩ and R2/R2″ connected to a 3.3V DC, with 1.65V threshold voltage of the controller 120:

R2/R2′ sinus(+)≈1040 kΩ→1μs in offset time.

R2/R2′ sinus(±)=1000 kΩ→0μs in offset time.

R2/R2′ sinus(−)≈960 kΩ→1μs in offset time.

Hence, it may be noted that 1 μs in offset time can be obtained either in positive sine or negative sine depending on the value of R2/R2′ in this particular example for USA.

In Europe 230V/50 Hz when R1 is 1000 kΩ and R2/R2′ connected to a 3.3V DC voltage, with 1.65V threshold voltage of the controller 120:

R2/R2″ sinus (+)≈1070 kΩ→1μs in offset time.

R2/R2″ sinus (±)≈1000 kΩ→Ops in offset time.

R2/R2″ sinus (−)≈940 kΩ→1μs in offset time.

Hence, it may be noted that 1 μs in offset time can be obtained either in positive sine or negative sine depending on the value of R2/R2″ in this particular example for Europe.

The offset time for different values for R1 and R2 in Ω for 240V AC when positive may be given according to the following Table 1.

TABLE 1

| R1 | R2 DC high (3.3 V) | R2 DC low (0 V) | Offset time |
|---|---|---|---|
| 1000 kΩ | ∞ | 500 kΩ | ≈24 μs |
| 1000 kΩ | ∞ | 1000 kΩ | ≈32 μs |
| 1000 kΩ | ∞ | ∞ | ≈16 μs |
| 1000 kΩ | 4000 kΩ | ∞ | ≈12 μs |
| 1000 kΩ | 2000 kΩ | ∞ | ≈8 μs |
| 1000 kΩ | 1000 kΩ | ∞ | ≈0 μs |

The ∞ sign denotes the case when R2 is not connected and since there is no resistor R2 connected which adds/subtracts a DC voltage, it is the sine waveform of the AC network 300 own time period to go from 1.65V to 0V that is noted, and it is in the example above about 16 μs for 230V/50 Hz.

Furthermore, as also shown in FIGS. 5 to 7, the second side of the second resistor R2 may be connected to a DC output 126 of the controller 120, which means that in such embodiments the DC output 126 of the controller 120 is configured to provide a DC voltage to the voltage divider 110. By using the DC output 126 of the controller 120 a low complex design may be provided since fewer components may be used. In examples, an inverted DC output of the controller 120 may be used when the DC voltage alternates between a high and low value. Thus, when the AC sine wave has a positive half period (negative incline) a low/zero DC is feed and when the AC sine wave has a negative half period (positive incline) a high DC is feed.

Moreover, for adapting or tuning the scaled voltage the values of the first resistor R1 and the second resistor R2 may be adjusted. Hence, a resistance value of the first resistor R1 may be constant and a resistance value of the second resistor R2 may be adjustable, or vice versa.

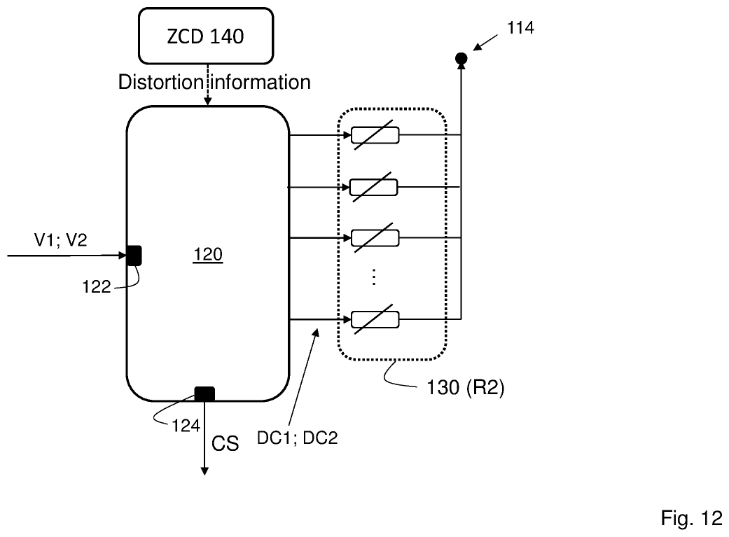

FIG. 12 shows an embodiment when the value of the second resistor R2 is adjusted by using a resistive network 130. A plurality of variable resistors is arranged in parallel to each other in the resistive network 130 and the variable resistors may have values in different intervals for desired granularity. Therefore, by combining the variable resistors of the resistive network 130 in different coupling configurations the value of the second resistor R2 can be controlled.

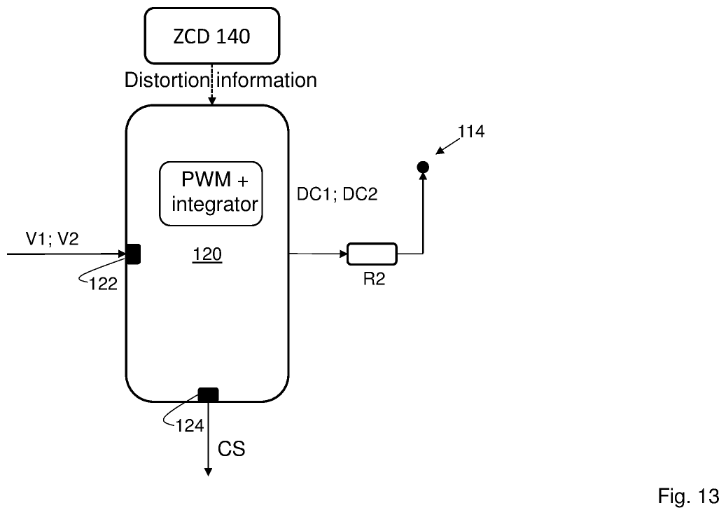

FIG. 13 on the other hand shows an embodiment of the invention when the value of the first resistor R1 and the second resistor R2 is a constant and the scaling of the AC voltage Vac is instead controlled by controlling the DC voltage feed to the second resistor R2. As disclosed a pulse wide modulation (PWM) circuit and an integrator circuit may be coupled to the second resistor R2. The PWM and integrator may be part of the controller 120 as shown in FIG. 13 but may also be a standalone device coupled to the voltage divider 110 (not shown in the Figs.). By varying the value of the DC voltage feed to the second resistor R2 instead of varying the value of second resistor R2 the scaling of the AC voltage of the AC network can be controlled.

Moreover, in yet further embodiments of the invention a feedback mechanism is provided for tuning the scaling of the AC voltage Vac. The tuning procedure may be performed in a start-up process and/or if the AC voltage of the AC network changes, e.g. more than a threshold value for the AC change. Thereby, connecting to or disconnecting from the AC network can be further improved by using the tuning procedure.

With reference to FIG. 12 according to embodiments of the invention, the adjustable resistance value may be adjusted based on a distortion information about the AC voltage Vac. In this respect a zero crossing detector (ZCD) 140 may be used as illustrated in FIGS. 12 and 13. The ZCD is configured to detect a transition of the sine waveform from positive to negative or vice versa and to provide distortion information based on such detection. The controller 120 may be configured to receive distortion information from the ZCD and depending on the distortion information adapt or tune the resistance value so as to properly scale the AC voltage to the threshold trigger value Vth and the total time delay Ttot for high accuracy.

With reference to FIG. 13 according to embodiments of the invention, instead of changing the value of R1 or R2 the DC voltage feed to the voltage divider 110 can be adapted. In this respect R1 and R2 have different but constant values. By adapting the DC voltage the scaling of the AC voltage can be controlled. Also, in this case distortion information from the ZCD can be used for controlling the DC voltage delivered to the voltage divider 110.

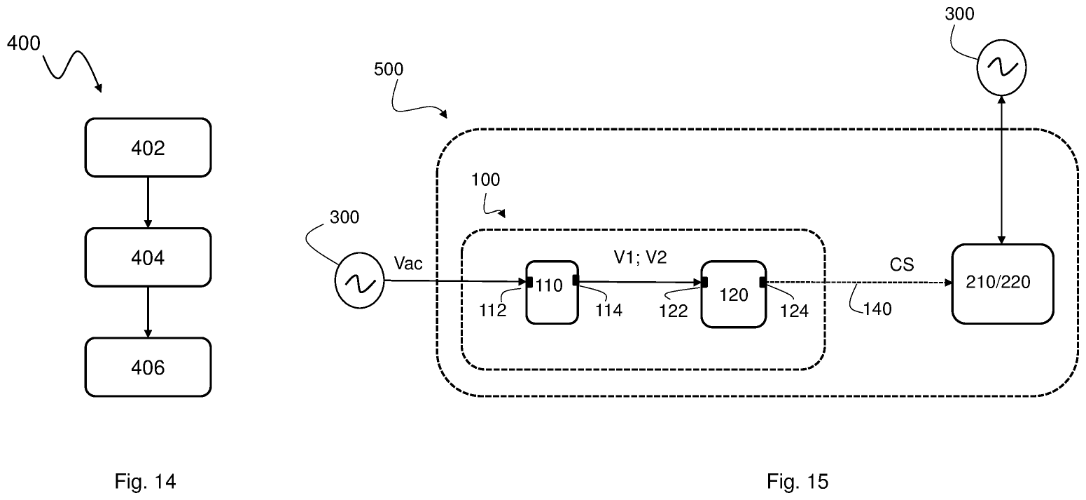

FIG. 14 shows a flow chart of a method according to embodiments of the invention. The method 400 herein disclosed is for connecting or disconnecting a power consumer and/or a power source to an AC network. With reference to FIG. 14 the method 400 comprises receiving 402 an AC voltage Vac of an AC network 300. The method 400 further comprises dividing 404 the AC voltage Vac for obtaining a divided voltage V1; V2 of the AC voltage Vac. The method 400 further comprises providing 406 a control signal 142 to a power consumer 210 and/or a power source 220 so as to connect or disconnect the power consumer 210 and/or the power source 220 to the AC network 300 when the divided voltage V1; V2 crosses a threshold trigger voltage Vth. It may be noted that the method previously described may be implemented such as to correspond to any embodiments of the circuit 100 herein disclosed.

FIG. 15 shows an arrangement 500 according to embodiments of the invention. The arrangement 500 comprises a circuit 100 according to embodiments of the invention and at least one power consumer 210 and/or at least one power source 220 which are configured to be connected and disconnected to the AC network 300 e.g. by switching means.

Finally, it should be understood that the invention is not limited to the embodiments described above, but also relates to and incorporates all embodiments within the scope of the appended independent claims.

1. A circuit for connecting or disconnecting a power consumer and/or a power source to an AC network, the circuit comprising:
a voltage divider comprising:
an input configured to receive an AC voltage of an AC network,
an output configured to provide a divided voltage of the AC voltage;
a controller comprising:
an input connected to the output of the voltage divider and configured to receive the divided voltage,
a control output connected to a power consumer and/or a power source for controlling the power consumer and/or the power source;
wherein the controller is configured to:
provide a control signal to the power consumer and/or the power source when the divided voltage crosses a threshold trigger voltage of the controller so as to connect or disconnect the power consumer and/or the power source to the AC network.

2. The circuit according to claim 1, wherein the absolute value of the threshold trigger voltage is larger than zero.

3. The circuit according to claim 1, wherein the amplitude of the divided voltage is smaller than the amplitude of the AC voltage.

4. The circuit according to claim 1, wherein the divided voltage has the same periodicity as the AC voltage.

5. The circuit according to claim 1, wherein the controller is configured to
provide the control signal at an offset time period being a time period when the divided voltage (V1; V2) crosses the threshold trigger voltage previous to or after a zero crossing of the AC voltage.

6. The circuit according to claim 5, wherein the offset time period is dependent on a control time delay being a sum of all time delays contributing to a total time period for connecting or disconnecting the power consumer and/or the power source to the AC network at the zero crossing of the AC voltage.

7. The circuit according to claim 1, wherein the voltage divider is a resistive voltage divider comprising
a first resistor connected in series with a second resistors, wherein a first side of the first resistor is connected to the AC network for receiving the AC voltage of the AC network and a second side of the first resistor is connected to a first side of the second resistor; and wherein
the output of the voltage divider is arranged between the first resistor and the second resistor.

8. The circuit according to claim 7, wherein a second side of the second resistor is configured to receive a DC voltage, and wherein a value of the DC voltage is dependent on an offset time period being a time period when the divided voltage crosses the threshold trigger voltage previous to or after the zero crossing of the AC voltage.

9. The circuit according to claim 8, wherein
the DC voltage is constant when the offset time period is smaller than an offset threshold time period; or
the DC voltage alternates between a low value and a high value when the offset time period is larger than an offset threshold time period.

10. The circuit according to claim 9, wherein the DC voltage alternates between a low value and a high value, and wherein the DC voltage has a low value when the AC voltage waveform has a negative incline, and a high value when the AC voltage waveform has a positive incline.

11. The circuit according to claim 10, wherein the low voltage value is 0 V, and the high voltage value is dependent on the trigger threshold voltage of the controller.

12. The circuit according to claim 7, wherein the second side of the second resistor is connected to a DC output of the controller, and wherein the DC output is configured to provide the DC voltage to the voltage divider.

13. The circuit according to claim 7, wherein
a resistance value of the first resistor is constant and a resistance value of the second resistor is adjustable, or vice versa; or
a resistance value of the first resistor is a first constant value and a resistance value of the second resistor is a second constant value.

14. The circuit according to claim 12, wherein the adjustable resistance value or the DC voltage is adjusted based on a distortion information about the AC voltage.

15. A method for connecting or disconnecting a power consumer and/or a power source to an AC network, the method comprising:
receiving an AC voltage of an AC network,
dividing the AC voltage for obtaining a divided voltage of the AC voltage; and
providing a control signal to a power consumer and/or a power source so as to connect or disconnect the power consumer and/or the power source to the AC network when the divided voltage crosses a threshold trigger voltage.
